(19) United States
(12) Patent Application Publication
(10) Pub. No.: US 2020/0196791 A1
(43) Pub. Date: Jun. 25, 2020

(54) APPARATUS TO PROVIDE ALERT BASED ON LIQUID BOILING MECHANISM

(71) Applicant: Josh SCHARF, Short Hills, NJ (US)

(72) Inventor: Josh SCHARF, Short Hills, NJ (US)

(21) Appl. No.: 16/725,106

(22) Filed: Dec. 23, 2019

Related U.S. Application Data
(60) Provisional application No. 62/783,449, filed on Dec. 21, 2018.

(51) Int. Cl. A47J 27/62; F24C 3/12; G05D 23/275

(52) U.S. Cl. CPC A47J 27/62; G05D 23/27543; F24C 3/126

(57) ABSTRACT

An apparatus for providing an alert based on a liquid boiling mechanism is described. The apparatus includes a probe. The probe includes a heat sensor enclosed by a protective material. The probe is configured to transmit a temperature measurement signal. The probe is also configured to be submerged in a liquid to be heated. The apparatus may also include a base unit communicatively connected to the probe. The base unit includes an alert disrupt control. The base unit is configured to emit an alert in response to a boiling temperature detected from the temperature measurement signal. The base unit is also configured to deactivate the alert in response to user action detected on the alert disrupt control.

### CLAIM OF PRIORITY

This application claims priority under 35 U.S.C. § 119 to United States provisional application No. 62/783,449 filed on Dec. 21, 2018 in the United States Patent and Trademark Office, the entire disclosure of which is incorporated herein by reference.

### FIELD OF THE EMBODIMENTS

The field of the present invention and its embodiments relate to an apparatus to alert a user when a monitored liquid reaches a boiling temperature.

### BACKGROUND OF THE EMBODIMENTS

According to The National Fire Protection Association, cooking fires are the number one cause of home fires and home injuries. The leading cause of fires in the kitchen is unattended cooking.

Kitchen fires may result in substantial damage to property and health. A major cause of kitchen fires may include unmonitored boiling liquids. For example, a pot or pan may be burned due to overcooking and cause a smoke condition and/or fire. As such, monitoring the liquid during heating and alerting a user to a boiling event may be crucial in prevention of a kitchen fire and/or injury to the person.

Examples of liquid monitoring are provided below.

For instance, GB Pat. 2523731 pertains to a temperature measuring device, or probe thermometer, comprising a housing having a handle portion, a body portion and a thermal probe that comprises a probe needle.

U.S. Pat. No. 9,289,096 pertains to a temperature control system for safely controlling the rate of flow of a flammable fluid at generally constant pressure.

U.S. Pat. No. 9,439,530 pertains to an intelligent cooking apparatuses that incorporates wireless communication technology to carryout cooking procedures.

US Pub. 2013/0301673A1 pertains to a method for determining false temperature measurements using a food temperature measuring device.

US Pub. 2016/0309548A1 pertains to an apparatus that processes food placed in a cavity by heating, cooking, or defrosting

Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments relate to an apparatus for providing an alert based on a liquid boiling mechanism. In an example embodiment of the present invention, the apparatus may include a probe. The probe may include a heat sensor enclosed by a protective material. The probe may be configured to transmit a temperature measurement signal. The probe may also be configured to be submerged in a liquid to be heated. The apparatus may also include a base unit communicatively connected to the probe. The base unit may include an alert disrupt control. The base unit may be configured to emit an alert in response to a boiling temperature detected from the temperature measurement signal. The base unit may also be configured to deactivate the alert in response to a user action detected on the alert disrupt control.

In another embodiment of the present invention, an apparatus for providing an alert based on a liquid boiling mechanism is described. The apparatus may include a probe. The probe may include a heat sensor enclosed by a protective material. The probe may be configured to transmit a temperature measurement signal. The probe may also be configured to be submerged in a liquid to be heated. The apparatus may also include a base unit connected to the probe. The base unit may be connected to the probe with a wire. The base unit may include an alert disrupt control. The base unit may be configured to emit an alert in response to a boiling temperature detected from the temperature measurement signal. The base unit may also be configured to deactivate the alert in response to a user action detected on the alert disrupt control. The apparatus may also include remote unit(s) communicatively coupled wirelessly to the base unit. The remote unit(s) may be configured to emit the alert.

In another embodiment of the present invention, an apparatus for providing an alert based on a liquid boiling mechanism is described. The apparatus may include a probe. The probe may include a heat sensor enclosed by a protective material. The probe may be configured to transmit a temperature measurement signal. The probe may also be configured to be submerged in a liquid to be heated. The apparatus may also include a base unit connected to the probe. The base unit may be connected to the probe with a wire. The base unit may include an alert disrupt control. The base unit may be configured to emit an alert in response to a boiling temperature detected from the temperature measurement signal. The base unit may also be configured to deactivate the alert in response to a user action detected on the alert disrupt control. The apparatus may also include a base unit that communicates with phones via a text message and/or prerecorded voice messages.

In yet another embodiment of the present invention, a method of providing an alert based on a liquid boiling mechanism is described. The method may include receiving a temperature measurement signal from a probe. The probe may be submerged in a liquid. The liquid may be heated. A temperature measurement may be detected within the temperature measurement signal as equaling or exceeding a boiling temperature associated with the liquid. Next, an alert may be emitted. The alert may include a visual alert and/or an audible alert. Furthermore, an alert signal may be transmitted wirelessly to a remote unit as well as initiate a text and/or voice message to phones. The remote unit may be configured to emit the alert in response to receiving the alert signal.

It is an object of the present invention to provide an apparatus configured to provide an alert in response to detecting a boiling temperature within a heating liquid.

It is an object of the present invention to continue to emit the alert until a user action to terminate the alert.

It is an object of the present invention to activate remote unit(s) wirelessly and prompt the remote unit(s) to emit alert(s).

It is an object of the present invention to deactivate the remote unit(s) wirelessly in response to a user action on terminate the alert(s).

These and other features, aspects and advantages of the present invention will become better understood with reference to the following drawings, description and claims.

### BRIEF DESCRIPTION OF THE DRAWINGS

FIG. 1 shows a conceptual view of embodiments of the present invention.

FIG. 2 shows a detailed view of an embodiment the present invention.

FIG. 3 shows an alternative view of an embodiment of the present invention.

FIG. 4 shows another view of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

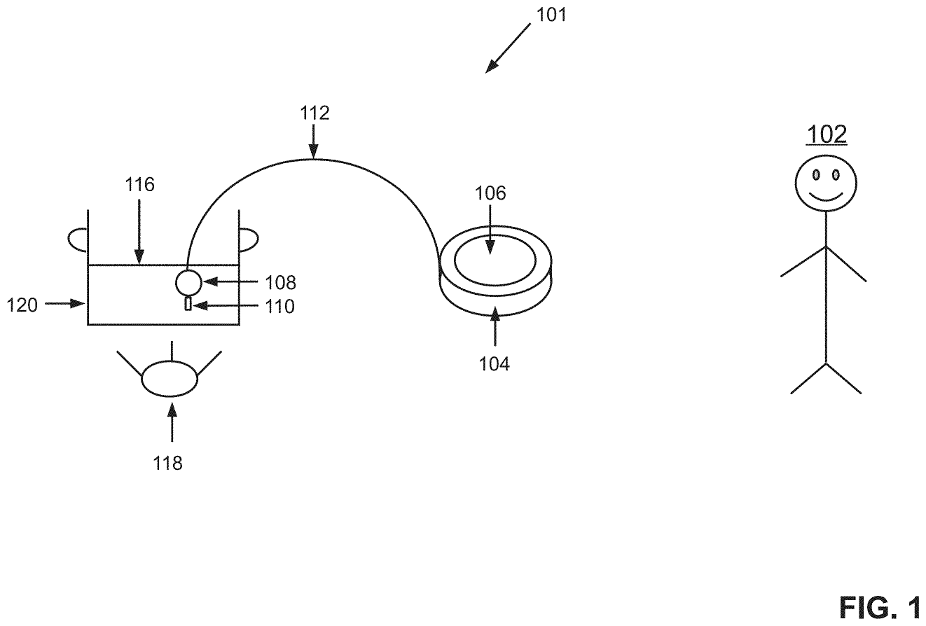

FIG. 1 shows a conceptual view of an apparatus 101 that provides an alert 114 based on a liquid boiling mechanism. Kitchen fires may result in substantial damage to property and health. A major cause of kitchen fires may include unmonitored cooking including boiling liquids. Furthermore, steam or vapors arising out of the boiling liquid (such as water) may damage a person who is unaware that the liquid is boiling. As such, monitoring the liquid during heating and alerting a user to a boiling event may be crucial in preventing a kitchen fire and/or injury to a person.

In an example scenario, the apparatus 101 may be configured provide the alert 114 to a user 102. The alert 114 is provided when a liquid 116 is detected as reaching a boiling temperature. The liquid 116 may include water, among others. An example of the boiling temperature may include approximately 100 degrees Celsius.

The liquid 116 may be stored in a container 120 (such as a pot and/or a pan, among others). The user 102 may apply heat to the liquid 116 by turning on a heat source 118.

The user 102 may also submerge a probe 108 into the liquid 116 to monitor a temperature of the liquid 116. The probe 108 may include a heat sensor 110. The heat sensor 110 may be configured to measure a temperature of the liquid 116. The probe 108 may also include wireless communication component(s) to allow the probe 108 to allow wireless communication.

The heat sensor 110 (and the wireless communication component(s)) may be covered in a protective material. An example of the protective material may include a silicon based material. Another example of the protective material may include a Kevlar based material. The protective material may also include a composite based material such as a combination of silicon and/or Kevlar, among others. The protective material may secure, enclose, and protect the heat sensor 110, wireless communication component(s) or a connection between the heat sensor and a wire 112. The wire 112 may be configured to carry the temperature measurement signal. As such, the probe 108 may be re-used (extensively) in harsh environments such as within the liquid 116 (that is heated to the boiling temperature).

In addition, the wire 112 may also be covered in the protective material (or other protective material). The wire 112 may be secured to operate within the harsh environment of the liquid 116 that is heated to the boiling temperature. As such, the wire 112 may be resistant to heat and wet conditions associated with the operational environment of the probe 108.

The probe 108 may transmit a temperature measurement signal (that includes the temperature measured by the heat sensor 110) to a base unit 104. The base unit 104 may include processing circuitry to monitor the temperature measurement signal and execute action(s) associated with the measured temperature.

The base unit 104 may be communicatively connected to the probe with the wire 112. The base unit 104 may be configured to monitor the temperature measurement signal received from the probe 108. In response to detecting a boiling temperature from the temperature measurement signal, the base unit 104 may emit the alert 114. The alert 114 may include a visual alert and/or an audible alert, among others. The user 102 may disrupt the alert 114 by executing a user action on an alert disrupt control 106. The user action may include the user pressing the alert disrupt control 106. The base unit 104 may be configured to continue to emit the alert 114 until detecting the user action on the alert disrupt control 106.

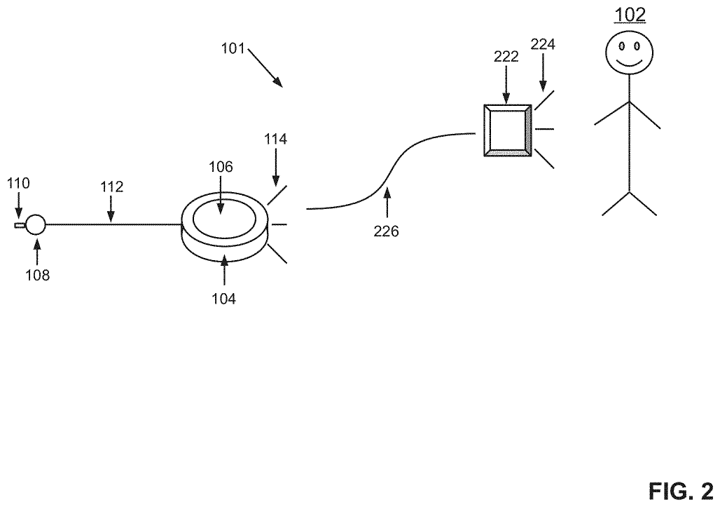

FIG. 2 shows a detailed view of the apparatus 101. The apparatus 101 may include the probe 108 with the heat sensor 110. The probe 108 may be submerged by the user 102 within a liquid that may be heated. The user 102 may wish to monitor the liquid and be alerted when the liquid reaches a boiling temperature.

The probe 108 may measure and transmit a temperature of the liquid within a temperature measurement signal through a wire 112 to the base unit 104. The wire 112 may connect the probe 108 to the base unit 104 and transmit the temperature measurement signal from the probe 108 to the base unit 104. The base unit 104 may monitor the temperature of the liquid from the temperature measurement signal and emit the alert 114 in response to detecting the boiling temperature associated with the liquid.

The apparatus 101 also include a remote unit 222 that is configured to emit an alert 224. The base unit 104 may be communicatively connected wirelessly with the remote unit 222. The base unit 104 may be configured to transmit an alert signal 226 to the remote unit 222 (in response to detecting a boiling temperature transmitted by the probe 108). The base unit 104 may transmit the alert signal 226 to the remote unit 222 in synchrony with an emission of the alert 114. As such, the remote unit 222 may be prompted to emit the alert 224 in synchrony with the emission of the alert 114 (by the base unit 104). The remote unit 222 may be configured to notify the user 102 regarding the detected boiling temperature when the user is away from a reach of the alert 114 emitted by the base unit 104.

Power sources of the base unit 104 and/or the remote unit 222 may include disposable battery(s) and/or rechargeable battery(s), among others. Alternatively, the base unit 104 and/or the remote unit 222 may receive power from an electrical power source such as a wall socket connected to an electrical grid.

The alert 114 and the alert 224 may continue to be emitted by the base unit 104 and the remote unit 222 until the user 102 is detected as executing a user action on the disrupt alert control 106. The user action may include an activation event associated with the disrupt alert control 106. In response to the user action, the base unit 104 may cease to emit the alert 114. The base unit 104 may also transmit the alert signal 226 to the remote unit 222 to prompt the remote unit 222 to cease an emission of the alert 224.

The heat sensor 110 (and/or other components within the probe 108) may include additional sensing components to detect a submerge event within the liquid. As such, a measurement of the temperature of the liquid may be initiated in response to the submerge event detected by the additional sensor(s). Similarly, the temperature measurement may be automatically ceased to be monitored in response to an event detected by the additional sensor(s) in which the probe 108 is removed from the liquid.

Furthermore, a type of the liquid may also be detected with other sensor(s) within the heat sensor or the probe 108. The type of the liquid may be communicated to the base unit 104. In response, the base unit 104 may configure the boiling temperature to match the type of the liquid.

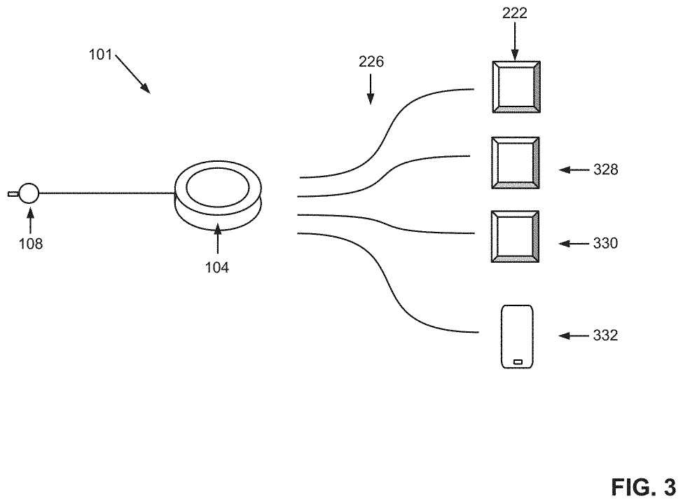

FIG. 3 shows an alternative view of the apparatus 101. The apparatus 101 may include the probe 108 that transmits a temperature measurement signal (associated with a monitored liquid) to the base unit 104. The base unit 104 may monitor the temperature of the liquid and emit an alert in response to detecting a boiling temperature. Furthermore, the base unit 104 may transmit alert signal(s) 226 to remote units (222, 328, and 330). The alert signal 226 may prompt the remote units (222, 328, and 330) to emit alerts. The base unit 104 may also transmit a subsequent alert signal in response to detecting a user action on an alert disrupt control. The subsequent alert signal may instruct the remote units (222, 328, and 330) to cease emissions of alerts.

The apparatus 101 may also transmit the temperature measurement signal to a mobile device 332. An example of the mobile device 332 may include a smart phone, a handheld device, and/or other devices that may be configured to communicate wirelessly. The base unit 104 may transmit the alert signal 226 to the mobile device 332 in response to detecting the boiling temperature in the temperature measurement signal. The mobile device 332 may emit an alert to the user to inform the user regarding the boiling temperature. The base unit 104 may also transmit a subsequent alert signal to instruct the mobile device 332 to stop emitting the alert when the base unit 104 detects a user action on the alert disrupt control.

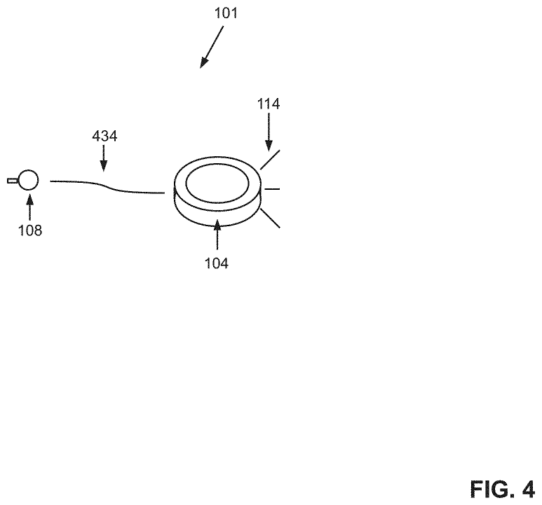

FIG. 4 shows another view of the apparatus 101. The apparatus 101 may include the probe 108. The probe may be configured to transmit the temperature measurement signal 434 wirelessly to the base unit 104. The temperature measurement signal 434 may be transmitted wirelessly over a wireless network such as a cellular network and/or a Wi-Fi network, among others. The base unit 104 may receive the temperature measurement signal 434. In response to detecting the boiling temperature within the temperature measurement signal 434, the base unit 104 may emit the alert 114 to inform the user and to prompt the user to take an action regarding the alert. The base unit 104 may also transmit an alert signal to prompt a remote unit and/or a mobile device to emit an alert. The base unit 104 may transmit the alert signal wirelessly to the remote unit and/or the mobile device.

A method of providing an alert based on a liquid boiling mechanism is also described. The method may include receiving a temperature measurement signal from a probe. The probe may be submerged in a liquid. The liquid may be heating. A temperature measurement may be detected within the temperature measurement signal as equaling or exceeding a boiling temperature associated with the liquid. Next, an alert may be emitted. The alert may include a visual alert and/or an audible alert. Furthermore, an alert signal may be transmitted wirelessly to a remote unit. The remote unit may be configured to emit the alert in response to receiving the alert signal.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus for providing an alert based on a liquid boiling mechanism comprising:
a probe, wherein
the probe includes a heat sensor enclosed by a protective material, wherein
the probe is configured to transmit a temperature measurement signal, and wherein
the probe is configured to be submerged in a liquid to be heated; and
a base unit communicatively coupled to the probe, wherein
the base unit includes an alert disrupt control, wherein
the base unit is configured to emit an alert in response to a boiling temperature detected from the temperature measurement signal, and wherein
the base unit is configured to deactivate the alert in response to a user action detected on the alert disrupt control.

2. The apparatus of claim 1, wherein the boiling temperature is approximately 100 degrees Celsius.

3. The apparatus of claim 1, wherein the liquid to be heated includes water.

4. The apparatus of claim 1, wherein the protective material includes a silicon based material.

5. The apparatus of claim 1, wherein the protective material includes a Kevlar based material.

6. The apparatus of claim 1, wherein the base unit is communicatively coupled to the probe with a wire.

7. The apparatus of claim 6, wherein the wire is covered with the protective material.

8. The apparatus of claim 6, wherein the protective material is configured to secure and protect a connection between the heat sensor and the wire.

9. The apparatus of claim 1, wherein the base unit is communicatively coupled to the probe wirelessly.

10. The apparatus of claim 1, wherein the alert includes one or more of an audible alert and a visual alert.

11. The apparatus of claim 1, wherein a power source of the base unit includes one or more disposable batteries or one or more rechargeable batteries.

12. The apparatus of claim 1, further comprising:
a remote unit coupled to the base unit, wherein the remote unit is configured to emit the alert.

13. The apparatus of claim 12, wherein the remote unit is connected to the base unit wirelessly.

14. The apparatus of claim 12, wherein a power source of the remote unit includes one or more disposable batteries or one or more rechargeable batteries.

15. The apparatus of claim 12, wherein the remote unit is configured to emit the alert in response to an alert signal received from the base unit.

16. The apparatus of claim 15, wherein the remote unit is configured to cease the alert in response to a cease alert signal received from the base unit.

17. An apparatus for providing an alert based on a liquid boiling mechanism comprising:
a probe, wherein
the probe includes a heat sensor enclosed by a protective material, wherein
the probe is configured to transmit a temperature measurement signal, and wherein
the probe is configured to be submerged in a liquid to be heated;
a base unit coupled to the probe, wherein
the base unit is communicatively connected to the probe with a wire, wherein
the base unit includes an alert disrupt control, wherein
the base unit is configured to emit an alert in response to a boiling temperature detected from the temperature measurement signal, and wherein
the base unit is configured to deactivate the alert in response to a user action detected on the alert disrupt control; and
one or more remote units communicatively coupled wirelessly to the base unit,
wherein the one or more remote units are configured to emit the alert.

18. A method of providing an alert based on liquid boiling mechanism, the method comprising:
receiving a temperature measurement signal from a probe, wherein the probe is submerged in a liquid, and wherein the liquid is heating;
detecting a temperature measurement within the temperature measurement signal as equaling or exceeding a boiling temperature associated with the liquid;
emitting an alert, wherein the alert includes one or more of a visual alert and an audible alert; and
transmitting an alert signal wirelessly to a remote unit, wherein the remote unit is configured to emit the alert in response to receiving the alert signal.
